(19) United States
(12) Patent Application Publication
(10) Pub. No.: US 2025/0211112 A1
(43) Pub. Date: Jun. 26, 2025

(54) DROOP CURRENT SHARING IN BIDIRECTIONAL CONVERTERS

(71) Applicant: Murata Manufacturing Co., Ltd., Nagaokakyo-shi, Kyoto-fu (JP)

(72) Inventor: Varshaan RUPPA, Westborough, MA (US)

(21) Appl. No.: 18/847,403

(22) PCT Filed: Mar. 23, 2023
(86) PCT No.: PCT/US2023/016023

§ 371 Date: Sep. 16, 2024

Related U.S. Application Data
(60) Provisional application No. 63/325,573, filed on Mar. 30, 2022.

(51) Int. Cl. H02M 3/158; H02M 1/00

(52) U.S. Cl. CPC H02M 3/158; H02M 1/0009

(57) ABSTRACT

A bidirectional converter includes first and second terminals between which a current flows and a current-sensing circuit electrically connected to only one of the first and the second terminals to sense the current. Current sensing is only performed at the one of the first terminal and the second terminal to which the current-sensing circuit is connected, and an output voltage of the bidirectional converter droops based on the sensed current.

### CROSS REFERENCE TO RELATED APPLICATIONS

This application claims the benefit of U.S. Patent Application No. 63/325,573 filed on Mar. 30, 2022. The entire contents of each application are hereby incorporated by reference.

### BACKGROUND OF THE INVENTION

### 1. Field of the Invention

The present invention relates to electrical converters. More specifically, the present invention relates to bidirectional converters with droop current sharing.

### 2. Description of the Related Art

In known bidirectional converters, two current-sensing circuits are typically provided, one for each power direction. Due to the bidirectional operation of the bidirectional converters, an input of a bidirectional converters when current or power flows in one direction is also an output when the current or power flows in the opposite direction. Accordingly, two current-sensing circuits are typically provided for known bidirectional converters, with one current-sensing circuit being provided at each input/output. The two current-sensing circuits can directly generate a current signal by sensing the current at each input/output. For example, current-sensing resistors and current-sensing amplifiers can be used as the current-sensing circuits. The current-sensing circuits can be bidirectional. Accordingly, due to the inclusion of current-sensing circuits, known bidirectional converters generally require a significant number of circuit components, and the bill-of-materials cost increases as well. Furthermore, when current-sensing resistors are implemented, known bidirectional converters have reduced efficiency due to power dissipation through the current-sensing resistors.

Droop current sharing is a known technique of current sharing of parallel-connected electrical modules that does not require any communication signals between the parallel-connected electrical modules. The parallel-connected electrical modules can include, for example, parallel-connected bidirectional converters. Droop current sharing can be provided by a variety of implementations, including providing a series resistance for a parallel connection of electrical modules such that an output voltage droops across the series resistance.

However, in high-current applications, the above implementation of droop current sharing can result in significant power dissipation through the series resistance. Although the power dissipation can be reduced by providing multiple resistors in parallel, including additional resistors increases the footprint of a droop current sharing circuit.

### SUMMARY OF THE INVENTION

Preferred embodiments of the present invention provide bidirectional converters with droop current sharing by including a current-sensing circuit and by modifying an output voltage to decrease as a load increases. In particular, preferred embodiments of the present invention provide current sensing in bidirectional converters at only one input/output of each of the bidirectional converters. Accordingly, current sensing can be implemented with a low number of components, at a low cost, and with a relatively simple implementation.

A bidirectional converter according to a preferred embodiment of the present invention includes first and second terminals between which a current flows and a current-sensing circuit electrically connected to only one of the first and the second terminals to sense the current. Current sensing is only performed at the one of the first terminal and the second terminal to which the current-sensing circuit is connected, and an output voltage of the bidirectional converter droops based on the sensed current.

The bidirectional converter may include a pulse-width modulator that receives a signal from the current-sensing circuit. The bidirectional converter may include a voltage measurement circuit electrically connected to only one of the first terminal and the second terminal. Alternatively, first voltage measurement circuit may be electrically connected to the first terminal, and a second voltage measurement circuit may be electrically connected to the second terminal.

The current-sensing circuit may include a current-sensing resistor through which the current flows. The current-sensing circuit may generate a signal proportional to the sensed current.

The current-sensing circuit may include at least one of a current-sensing integrated circuit and an operational amplifier circuit. The current-sensing circuit may include a metal-oxide-semiconductor field-effect transistor, and the current-sensing circuit may further include a temperature compensation circuit. The current-sensing circuit may include a bus bar, a wire, or a trace of a printed circuit board.

The bidirectional converter may further include a microcontroller that is configured and/or programmed to receive an analog-to-digital converted signal corresponding to the sensed current, to compare the analog-to-digital converted signal with a predetermined current protection limit, and to modulate a PWM signal in response to the analog-to-digital converted signal reaching the predetermined current protection limit.

The bidirectional converter may be a DC-DC converter. The bidirectional converter may be an isolated bidirectional converter.

A bidirectional converter system may include first and second bidirectional converters. The first terminals of the first and the second bidirectional converters may be connected to each other, and the second terminals of the first and the second bidirectional converters may be connected to each other. The first and the second bidirectional converters do not have to share a current-sensing signal.

The above and other features, elements, steps, configurations, characteristics, and advantages of the present invention will become more apparent from the following detailed description of preferred embodiments of the present invention with reference to the attached drawings.

### BRIEF DESCRIPTION OF THE DRAWINGS

FIG. 1 shows a bidirectional converter system including parallel-connected, bidirectional converters.

FIG. 2 shows an implementation of a current-sensing circuit when power flows from a high side to a low side of a single bidirectional converter.

FIG. 3 shows the current-sensing circuit of FIG. 2 when power flows from a low side to a high side of a single bidirectional converter.

FIGS. 4A and 4B show operation of current-sensing circuits of a single bidirectional converter.

FIG. 5A shows a graph of a high-side current signal.

FIG. 5B shows a microcontroller that receives current signals and outputs a PWM signal.

FIG. 5C shows a graph of a low side current signal.

### DETAILED DESCRIPTION OF PREFERRED EMBODIMENTS

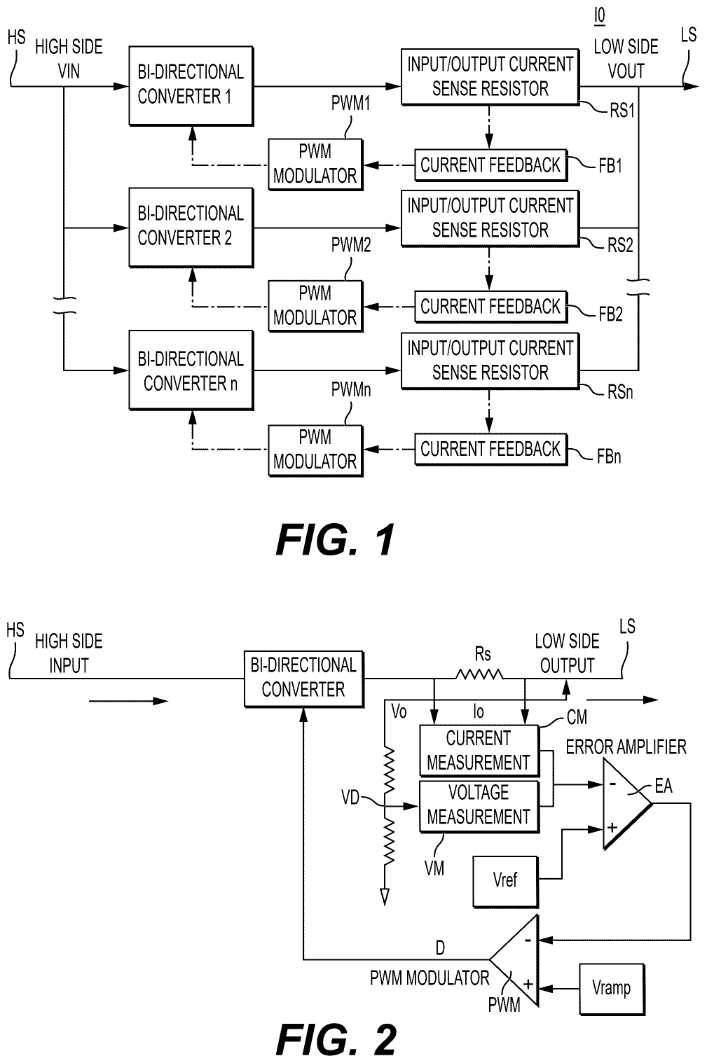

FIG. 1 shows a bidirectional DC-DC converter system 10 including bidirectional converters 1, . . . , n connected in parallel. Any number of bidirectional converters can be provided. The bidirectional converters 1, . . . , n can include DC-DC converters and can be isolated or non-isolated. In any isolated bidirectional converter, isolators can be used to send signals across the isolation barrier between the primary side and the secondary side of the isolated bidirectional converter. Any suitable isolator can be used, including, for example, current transformer, opto-isolator, digital isolator, etc.

Each of the bidirectional converters 1, . . . , n can include a first terminal HS on the high voltage side (or “high side”) and include a second terminal LS on the low voltage side (or “low side”). Current or power can flow both from the high side to low side, i.e., from the first terminal HS to the second terminal LS, and from the low side to the high side, i.e., from the second terminal LS to the first terminal HS. As shown in FIG. 1, each of the bidirectional DC-DC-converters 1, . . . , n can include a droop-share circuit that includes an input/output current-sensing resistor Rs1, . . . , Rsn connected between the bidirectional converter 1, . . . , n and the output voltage Vout, a current feedback circuit FB1, . . . , FBn connected to the input/output current-sensing resistor Rs1, . . . , Rsn, and a pulse-width modulation (PWM) modulator PWM1, . . . , PWMn that receives a signal from the current feedback circuit FB1, . . . , FBn and that provides a signal to the bidirectional converter 1, . . . , n that causes bidirectional converter 1, . . . , n to droop, i.e., the output voltage Vout of the bidirectional converter 1, . . . , n decreases with increasing current. Depending on the direction of current or power flow in the bidirectional converter, the current either can be the output or load current when current flows from the high side to the low side or can be the input or line current when current flows from the low side to the high side. Each of the bidirectional converters 1, . . . , n can include a microcontroller that is configured and/or programmed to provide the functions described herein. Any suitable microcontroller can be used.

As shown in FIG. 1, a single input/output current-sensing resistor Rs1, . . . , Rsn can be provided for each of the bidirectional converters 1, . . . , n. Although FIG. 1 shows that the input/output current-sensing resistors Rs1, . . . , Rsn can be located at the low side of the bidirectional converter system 10, the input/output current-sensing resistors Rs1, . . . , Rsn can also be located at the high side of the bidirectional converter system 10. If the bidirectional converters are isolated, then the current-sensing signals can be sent across the isolation barrier between the primary side and the secondary side using an isolator. Each of the input/output current-sensing resistors Rs1, . . . , Rsn can, collectively, be located at the same side of the bidirectional converter system 10. By providing the input/output current-sensing resistors Rs1, . . . , Rsn at only a single side of each of the converters 1 to n, the overall the number of components included in the bidirectional converter system 10 can be reduced, and the circuitry included in the bidirectional converter system 10 can be simplified.

During buck mode operation of the bidirectional converter system 10 shown in FIG. 1, power flows from the high side to the low side. An output current is sensed across the input/output current-sensing resistors Rs1, . . . , Rsn (which are located at the low side), and a signal is generated by the current feedback circuit FB1, . . . , FBn which is proportional to the output current that can be used as feedback to modify the output voltage of the bidirectional converters 1, . . . , n.

During boost mode operation of the bidirectional converter system 10 shown in FIG. 1, power flows from the low side to the high side. That is, the output and input sides of the bidirectional converter system 10 are reversed. In boost mode operation, an input current is sensed across the input/output current-sensing resistors Rs1, . . . , Rsn, and a signal is generated by the current feedback circuit FB1, . . . , FBn that is proportional to the input current that can be used as feedback to modify the input voltage of the bidirectional converter 1, . . . , n.

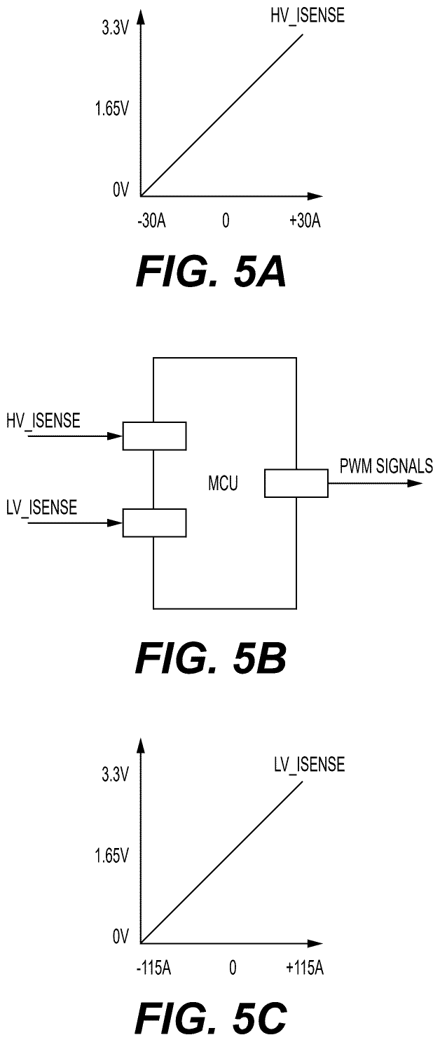

FIG. 2 shows an implementation of a current-sensing circuit when power flows from the high side to the low side of a single bidirectional converter. The current-sensing circuit shown in FIG. 1 can be used with each of the bidirectional converters 1, . . . , n in FIG. 1. The output or load current Io on the low side across the input/output current-sensing resistor Rs can be measured using a current measurement circuit CM, and the output voltage Vo on the low side can be measured using a voltage measurement circuit VM. As shown in FIG. 2, a voltage divider VD can be used to provide a signal to the voltage measurement circuit VM. Each of the current measurement circuit CM and the voltage measurement circuit VM can provide a signal to an error amplifier EA. As shown in FIG. 2, a reference voltage Vref can be provided to the error amplifier EA. The reference voltage Vref is determined according to a no-load value of the output current Io. Based on the signals from the current measurement circuit CM and voltage measurement circuit VM and the reference voltage Vref, the error amplifier EA provides an error signal to the PWM modulator PWM. As shown in FIG. 2, a ramp signal Vramp can be provided to the PWM modulator PWM. Based on the error signal and the ramp signal Vramp, the PWM modulator PWM can provide a duty signal D to the bidirectional converter to regulate the output voltage Vo to implement droop current sharing by causing the output voltage Vo to decrease as the output current Io increases. The bidirectional converter's current setting can be adjusted by varying the value of the current-sensing resistor Rs, and the voltage setting can be adjusted by varying the values of the resistors included in the voltage divider VD. PWM control can be performed by a microcontroller (for example, the microcontroller MCU shown in FIG. 5B) or an analog integrated circuit.

To implement droop current sharing in the bidirectional converter system 10 shown in FIG. 1, current sensing can be performed using a current-sensing integrated circuit (IC), an operational amplifier circuit to provide current feedback, a microcontroller, and the like. FIG. 4A shows an example of droop current sensing that includes a bi-directional current-sensing IC, when power flows from the high side to the low side. The bi-directional current-sensing IC can be implemented by, for example, a bi-directional current-sensing amplifier INA282 manufactured by TEXAS INSTRUMENTS.

As shown in FIGS. 2 and 4A, an output current Io through an input/output current-sensing resistor Rs can be detected by a current measurement circuit CM, and the current measurement circuit CM can be implemented by a bi-directional current-sensing IC CS.

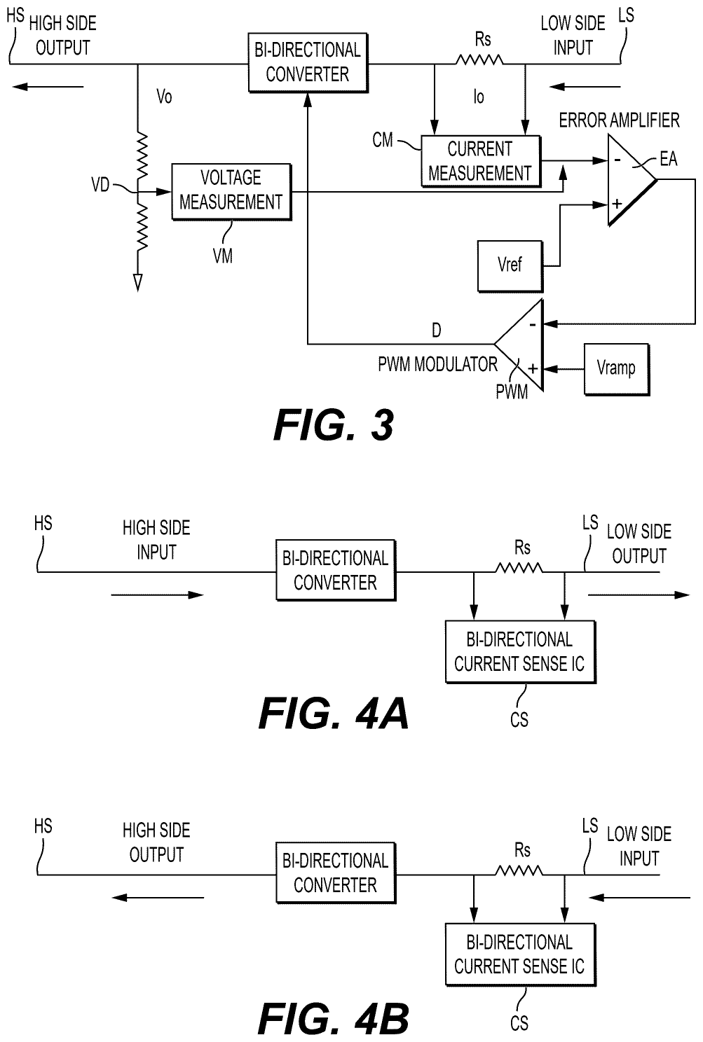

FIG. 3 shows the current-sensing circuit of FIG. 2 when power flows from the low side to the high side of the single bidirectional converter. The current-sensing circuit shown in FIG. 3 can be used with each of the bidirectional converters 1, . . . , n in FIG. 1. The input or line current Io on the low side across the input/output current-sensing resistor Rs can be measured using a current measurement circuit CM, and the output voltage Vo on the high side can be measured using a voltage measurement circuit VM. As shown in FIG. 3, a voltage divider VD can be used to provide a signal to the voltage measurement circuit VM. Each of the current measurement circuit CM and the voltage measurement circuit VM can provide a signal to an error amplifier EA. If the bidirectional converter is isolated, then an isolator can be used to provide the signal from the voltage measurement circuit VM to the error amplifier EA. As shown in FIG. 3, a reference voltage Vref can be provided to the error amplifier EA. Based on the signals from the current measurement circuit CM and voltage measurement circuit VM and the reference voltage Vref, the error amplifier EA provides an error signal to the PWM modulator PWM. As shown in FIG. 3, a ramp signal Vramp can be provided to the PWM modulator PWM. Based on the error signal and the ramp signal Vramp, the PWM modulator PWM can provide a duty signal D to the bidirectional converter to regulate the output voltage Vo to implement droop current sharing by causing the output voltage Vo decrease as the input current Io increases.

As shown in FIGS. 2 and 3, a voltage measurement circuit VM can be located at either the low side or the high side of a bidirectional converter. Voltage measurement is provided for the output voltage Vout, such that the location of the voltage measurement circuit VM is dependent upon the direction of power flow in the bidirectional converter. Accordingly, in a bidirectional converter that is to be operated to provide power flow both from the low side to the high side and from the high side to the low side, voltage measurement circuits VM can be provided at both the low side and the high side.

FIG. 4B shows an example of droop current sensing that includes a bi-directional current-sensing IC CS when power flows from the low side to the high side. As shown in FIG. 3, an input voltage feedback is provided by a signal generated from the input current Io sensed across the input/output current-sensing resistor Rs.

Current sensing can be implemented using a metal-oxide-semiconductor field-effect transistor (MOSFET) instead of the input/output current-sensing resistor Rs described above. By eliminating the input/output current-sensing resistor Rs, a loss of power caused by including this series-connected resistor can be eliminated. Further, omitting the input/output current-sensing resistor Rs can reduce the overall number of circuit components, reduce a footprint required by the overall circuit, and provide an overall increase in efficiency. However, current sensing by a MOSFET relies on the Rds ON value of the MOSFET, which can vary with temperature. Because the Rds ON value of a MOSFET tends to increase as temperature increases, additional temperature compensation circuitry may be required to implement a MOSFET instead of the input/output current-sensing resistor Rs.

Current sensing can also be implemented using a trace of a printed circuit board (PCB) instead of the input/output current-sensing resistor Rs. In relatively low current applications, a voltage drop across a PCB trace can be used to sense current, thereby reducing the overall space and footprint required by the current-sensing circuitry. As an alternative to PCB traces, bus bars or wires could also be used to sense current, for example. However, in higher current applications, the cost and weight required to implement a PCB trace or the like for current sensing may not provide an increase in efficiency over the input/output current-sensing resistor Rs described above.

Current sensing can be implemented with a microcontroller. As shown in FIG. 5B, a microcontroller MCU can receive signals corresponding to the high-side current HV_ISENSE shown in FIG. 5A and the low-side current LV_ISENSE shown in FIG. 5C. That is, the microcontroller MCU can receive analog-to-digital converted signals from the high side and the low side current measurement circuits (i.e., HV_ISENSE and LV_ISENSE). A predetermined current protection limit can be set by the microcontroller MCU so that when the high-side current HV_ISENSE or the low-side current LV_ISENSE reaches the predetermined current protection limit, a PWM signal is modulated to change the output voltages.

Preferred embodiments of the present invention can be applied to droop sharing in any bidirectional converter system that includes bidirectional converters connected in parallel. Further, preferred embodiments of the present invention can be implemented for both isolated and non-isolated bidirectional converters. In an isolated implementation, an isolator may be included to send the current-sensing signal either to the primary or secondary side of an isolated bidirectional converter, since the current-sensing circuit is located on only one side of the isolated bidirectional converter.

Although the current-sense circuits discussed above are provided at a low side of bidirectional converter systems, the current-sensing circuits can also be provided at a high side of bidirectional converter systems. For example, in a high-current application of up to about 110 A, current-sensing circuits can be provided at the high side, as the conduction loss is low and thus a cost of the components of the current-sensing circuits can be reduced. As a specific example, in a high-current system having an input voltage Vin of about 350 V, an output voltage Vout of about 50 V, an output current Io of about 110 A, and a power of about 5500 W, a bidirectional converter operating at about 95% efficiency would draw an input current of about 16.5 A. Accordingly, a current-sensing resistor of about 1 mΩ located at the high side (input) would have a conduction loss of about 0.27 W, whereas the same current-sensing resistor located at the low side (output) would have a conduction loss of about 12.1 W. Thus, providing the current-sensing resistor at the high side (input) is able to provide lower conduction losses.

Alternatively, in low-current applications of up to about 15 A, the current-sensing circuits can be provided at the low side to provide increased accuracy. During low-current conditions, any detection error of a current-sensing amplifier is primarily generated by a voltage offset that is inherent in current-sensing amplifiers, due to a voltage drop across the current-sensing resistor being less in low-current conditions. As a specific example, in a low-current system having an input voltage Vin of about 350 V, an output voltage Vout of about 50 V, an output current of about 15 A, and a power of about 5250 W, a bidirectional converter operating at about 95% would draw an input current of about 110.52 A. Accordingly, a current-sensing resistor provided at the low side (input) can provide higher accuracy due to the low side (input) having a higher current and thus higher voltage drop across the current-sensing resistor.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1: A bidirectional converter comprising:
first and second terminals between which a current flows; and
a current-sensing circuit electrically connected to only one of the first and the second terminals to sense the current; wherein
current sensing is only performed at the one of the first terminal and the second terminal to which the current-sensing circuit is connected; and
an output voltage of the bidirectional converter droops based on the sensed current.

2: The bidirectional converter according to claim 1, further comprising a pulse-width modulator that receives a signal from the current-sensing circuit.

3: The bidirectional converter according to claim 1, further comprising a voltage measurement circuit electrically connected to only one of the first terminal and the second terminal.

4: The bidirectional converter according to claim 1, wherein:
a first voltage measurement circuit electrically connected to the first terminal; and
a second voltage measurement circuit electrically connected to the second terminal.

5: The bidirectional converter according to claim 1, wherein the current-sensing circuit includes a current-sensing resistor through which the current flows.

6: The bidirectional converter according to claim 5, wherein the current-sensing circuit generates a signal proportional to the sensed current.

7: The bidirectional converter according to claim 1, wherein the current-sensing circuit includes at least one of a current-sensing integrated circuit and an operational amplifier circuit.

8: The bidirectional converter according to claim 1, wherein the current-sensing circuit includes a metal-oxide-semiconductor field-effect transistor.

9: The bidirectional converter according to claim 8, wherein the current-sensing circuit further includes a temperature compensation circuit.

10: The bidirectional converter according to claim 1, wherein the current-sensing circuit includes a bus bar, a wire, or a trace of a printed circuit board.

11: The bidirectional converter according to claim 1, further comprising a microcontroller that is configured and/or programmed to:
receive an analog-to-digital converted signal corresponding to the sensed current;
compare the analog-to-digital converted signal with a predetermined current protection limit; and
modulate a PWM signal in response to the analog-to-digital converted signal reaching the predetermined current protection limit.

12: The bidirectional converter according to claim 1, wherein the bidirectional converter is a DC-DC converter.

13: The bidirectional converter according to claim 1, wherein the bidirectional converter is an isolated bidirectional converter.

14: A bidirectional converter system comprising:
first and second bidirectional converters according to claim 1; wherein
the first terminals of the first and the second bidirectional converters are connected to each other; and
the second terminals of the first and the second bidirectional converters are connected to each other.

15: The bidirectional converter system according to claim 14, wherein the first and second bidirectional converters do not share a current-sensing signal.
